(19) United States
(12) Patent Application Publication
(10) Pub. No.: US 2017/0063294 A1
(43) Pub. Date: Mar. 2, 2017

(54) CONCENTRATING SOLAR REFLECTOR AND POWER SYSTEM

(71) Applicant: SunPower Corporation, San Jose, CA (US)

(72) Inventors: David Okawa, Belmont, CA (US); Sy Olson, Oakland, CA (US); Zachary Judkins, Berkeley, CA (US)

(21) Appl. No.: 14/838,030

(22) Filed: Aug. 27, 2015

(51) Int. Cl. H02S 40/22

(52) U.S. Cl. CPC H02S 40/22; F24J 2002/0046

(57) ABSTRACT

Concentrating reflectors for solar energy systems can include compound curvatures producing distinct beams of light which can be aimed and shaped so as to be superimposed at a desired location, such as a plane or a solar energy receiver. Additionally, the distinct beams can have different converging characteristics producing different irradiation intensity patterns on the desired location and which when added, produce more uniform irradiation intensity distribution over the desired location.

### TECHNICAL FIELD

Embodiments of the subject matter described herein relates generally to solar concentrators. For example, embodiments of the subject matter relate to concentrating reflectors used for concentrated photovoltaic solar systems.

### BACKGROUND

Concentrated solar power systems are different from unconcentrated solar power systems in a number of ways. Firstly, unconcentrated solar power systems are exposed to direct focused or diffused sunlight which generally strikes individual solar modules with a high degree of uniformity. Concentrated solar power systems, on the other hand, include curved reflectors designed to concentrate direct focused sunlight onto a smaller solar receiver. Additionally, many systems are designed so that the curved concentrator redirect the sunlight in a direction skewed relative to the direction of incident light from the sun, making the optical geometry more complicated.

Additionally, because concentrated solar power systems concentrate the sunlight directed at the solar receivers, the receivers of a concentrated solar power system must be designed to withstand higher temperatures and greater amounts of solar irradiation.

The solar cells used in both concentrated and unconcentrated solar modules are essentially the same, albeit tuned for different maximum levels of irradiation exposure. However, both types of solar cells experience decreased or impaired performance when irradiated in a non-uniform manner. For example, solar modules designed for nonconcentrated systems can be completely shut down when a single solar module is partially shaded.

On the other hand, solar receivers for concentrated solar systems are desirably fine tuned based on the predicted magnitude of irradiation, and more particularly, the maximum predicted irradiation intensity, anywhere on the exposed surface of the receiver.

Thus, if a solar receiver for a concentrated solar system is exposed to a non-uniform concentrated irradiation, for example, which may impact a limited portion of the receiver, the entire receiver, including the solar cells, would be designed to withstand that maximum predicted irradiation intensity. Such predicted maximum irradiation intensity also affects the design of thermal management devices, such as heat sinks and active cooling devices designed for cooling the solar cells so as to withstand the predicted maximum irradiation intensity.

### SUMMARY

An aspect of at least one of the embodiments disclosed herein includes the realization that certain non-uniformities which inherently result from certain concentrator-receiver geometries, can be combined in a way so as to offset each other so as to provide more uniform irradiation of an associated receiver.

For example, with some concentrator-receiver pair designs, one edge, such as a lower edge of the concentrating reflector, is closer to the receiver than an upper edge. Thus, when light is reflected onto the receiver, in a converging beam, the intensity of the light received at the receiver from the bottom edge of the reflector is more intense than the light received at the receiver reflected by the top edge of the reflector. The resulting irradiation intensity profile is therefore decreasing in the vertical direction along the height of the receiver. An example of such an irradiation intensity profile illustrated in FIG. 7 described in greater detail below.

On the other hand, if the curvature of the concentrating reflector is designed to create a focal point before striking the receiver, the resulting intensity profile is inverted, for example, increasing in intensity in the height direction, in the example described above. Thus, if a concentrating reflector is configured with two different curvatures, providing two beams having different characteristics, e.g., different focal points, the different intensity profiles generated by these two different curves can be combined, resulting in a more uniform intensity profile.

Thus, in accordance with an embodiment, a concentrated solar power unit can comprise a paired sunlight concentrating reflector and photovoltaic receiver, arranged such that incoming sunlight from the sun is reflected by the first sunlight concentrating reflector, onto the first photovoltaic receiver. The sunlight concentrating reflector can have a reflective side facing a sunlight sensitive side of the photovoltaic receiver, the sunlight sensitive side of the photovoltaic receiver comprising a receiver lower edge, a receiver upper edge, and a light sensitive portion disposed between the received upper edge and the receiver lower edge, the sunlight concentrating reflector comprising a concentrator lower edge and a concentrator upper edge. The reflective side of the sunlight concentrating reflector can comprise a first lower portion extending between the concentrator lower edge and an intermediate point on the reflective side and a first upper portion extending between the intermediate point and the concentrator upper edge. The first lower portion of the reflective side can have a first curvature configured to reflect the incoming sunlight into a first lower beam projecting a first band of reflected sunlight extending over substantially an entire height of the light sensitive portion of the first photovoltaic receiver. The first upper portion of the reflective side can have a second curvature configured to reflect the incoming sunlight into a first upper beam projecting a second band of reflected sunlight overlapping the first band of reflected sunlight. One of the first lower beam and the first upper beam has a first focal point between the reflective side and the sunlight sensitive portion and the other of the first lower beam and the first upper beam has a second focal point that is not between the reflective side and the sunlight sensitive portion.

In accordance with another embodiment, a concentrating reflector can comprise a concave, reflective surface extending along a longitudinal direction having first and second longitudinal ends and extending in a transverse direction between upper and lower edges. The reflective surface comprising at least a first portion having a first curvature, a second portion having a second curvature, and an intermediate portion disposed between the first and second portions. The first portion of the reflective surface extending between the lower edge and the intermediate portion, the second portion of the reflective surface extending between the upper edge and the intermediate portion. The first and second curvatures being configured to reflect first and second reflected beams of light, respectively, which are substantially coincident at a plane spaced from the reflective surface, forming a planar band of light comprising a superposition of the first and second beams. The first reflected beam of light has a first focal point and the second reflected beam of light has a second focal point, the second focal point spaced closer to the reflective surface than the first focal point, the plane being disposed between the first and second focal points.

In accordance with yet another embodiment, a concentrated solar power unit can comprise a photovoltaic receiver and a sunlight concentrating reflector having a reflective side facing toward a light sensitive portion of the photovoltaic receiver, the reflective side comprising a lower portion extending between a lower edge of the reflective side and an intermediate point on the reflective side, and an upper portion extending between the intermediate point and an upper edge of the reflective side. The lower portion reflecting sunlight into a lower beam projecting a first band of reflected sunlight onto a light sensitive portion of the photovoltaic receiver. The upper portion of the reflective side reflecting sunlight into an upper beam projecting a second band of reflected sunlight overlapping the first band of reflected sunlight. One of the lower beam and the upper beam has a first focal point between the reflective side and the sunlight sensitive portion and the other of the first lower beam and the first upper beam has a second focal point that is not between the reflective side and the sunlight sensitive portion.

In accordance with yet another embodiment, a concentrated solar power unit can comprise a photovoltaic receiver having a light sensitive portion and means for directing first and second beams of reflected sunlight, respectively, the first and second beams of impinging on the light sensitive side of the photovoltaic receiver with first and second different, non-uniform, irradiation intensity profiles, and summing the first and second beams of light so as to produce a resulting irradiation intensity profile that is more uniform than both of first and second different, non-uniform, irradiation intensity profiles.

In accordance with yet another embodiment, a concentrated solar power system can comprise an array of paired sunlight concentrating reflectors and photovoltaic receivers, the array including at least a plurality of first sunlight concentrating reflectors and a plurality of first photovoltaic receivers. Each of the first sunlight concentrating reflectors and each of the first photovoltaic receivers can be arranged such that incoming sunlight from the sun is reflected by the first sunlight concentrating reflectors, along a reflected direction skewed relative to the incoming sunlight, onto the first photovoltaic receivers. Each of the first sunlight concentrating receivers having a reflective side facing toward a sunlight sensitive side of respective first photovoltaic receivers, the sunlight sensitive side of the first photovoltaic receivers comprising a receiver lower edge and a receiver upper edge, the first sunlight concentrating reflectors comprising a concentrator lower edge and a concentrator upper edge, wherein the first photovoltaic receivers are fixed in an orientation such that a lower spacing between the receiver lower edges and the concentrator lower edges is smaller than an upper spacing between the receiver upper edges and the concentrator upper edges. The reflective sides of each of the first sunlight concentrating reflectors comprising a first lower portion extending between the concentrator lower edge and an intermediate point on the reflective side and a first upper portion extending between the intermediate point and the concentrator upper edge. Each of the first lower portions of the reflective sides having a first curvature configured to reflect and concentrate the incoming sunlight into a first concentrated beam projecting a first band of reflected sunlight extending substantially an entire height of the light sensitive side of a respective one of the first photovoltaic receivers between the receiver upper and receiver lower edges and with a first focal point further from the reflective surface than the light sensitive surface. The first upper portion of each of the reflective sides comprises a second curvature configured to reflect and concentrate the incoming direct sunlight into a second concentrated beam projecting a second band of reflected sunlight overlapping the first band of reflected sunlight with a second focal point disposed between the reflective surface and the light sensitive surface.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic diagram of a solar energy collection system illustrating optional electrical connections of the collector system with various electrical components;

FIG. 2 is a schematic side elevational view of an embodiment of a solar energy collection system, in the configuration of a concentrated photovoltaic solar energy collection system;

FIG. 3 is a partial perspective view of the system illustrated in FIG. 2;

FIG. 4 is a detailed side view of an embodiment;

FIG. 5 is a schematic side elevational view of yet another embodiment;

FIG. 6 is a schematic side elevational view of yet another embodiment;

FIG. 7 is a graph of an irradiation intensity profile of a portion of the concentrating reflectors of FIGS. 4-6 and 10-16;

FIG. 8 is an irradiation intensity profile that can represent the resulting irradiation intensity profiles of the certain parts of the embodiments of FIGS. 4-6 and 10-16;

FIG. 9 is an example of an irradiation intensity profile that can result from the superposition of beams of light reflected by different parts of the embodiment of FIGS. 4-6 and 10-16;

FIG. 10 is a schematic perspective view of an embodiment of a concentrating reflector and a reflected beam of light from a lower portion of the concentrator;

FIG. 11 is a further schematic view of the concentrator of FIG. 10 illustrating an upper beam of reflected light;

FIG. 12 is a schematic diagram of an intermediate beam of light produced by an intermediate portion of a concentrating reflector that can be included in the embodiments of FIGS. 10 and 11;

FIG. 13 is a schematic perspective view of the embodiment of a concentrator of FIGS. 10 and 11 with both beams of light illustrated and intersecting at a plane;

FIG. 14 is a schematic perspective view of yet a further embodiment including a paired concentrating reflector and photovoltaic receiver and two superimposed beams of light projecting a band of light onto a photovoltaic receiver;

FIG. 15 is a schematic perspective view of a further embodiment of a paired concentrator and receiver, wherein the concentrator produces three superimposed beams of light;

FIG. 16 is a schematic perspective view of yet another embodiment of a paired concentrating reflector and a receiver, where the concentrator creates four beams of light which are superimposed at the receiver.

### DETAILED DESCRIPTION OF EMBODIMENTS

The following detailed description is merely illustrative in nature and is not intended to limit the embodiments of the subject matter or the application and uses of such embodiments. As used herein, the word “exemplary” means “serving as an example, instance, or illustration. Any implementation described herein as exemplary is not necessarily to be construed as preferred or advantageous over other implementations. Furthermore, there is no intention to be bound by any expressed or implied theory presented in the preceding technical field, background, brief summary or the following detailed description.

“Coupled”—the following description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically.

“Adjust”—Some elements, components, and/or features are described as being adjustable or adjusted. As used herein, unless expressly stated otherwise, “adjust” means to position, modify, alter, or dispose an element or component or portion thereof as suitable to the circumstance and embodiment. In certain cases, the element or component, or portion thereof, can remain in an unchanged position, state, and/or condition as a result of adjustment, if appropriate or desirable for the embodiment under the circumstances. In some cases, the element or component can be altered, changed, or modified to a new position, state, and/or condition as a result of adjustment, if appropriate or desired.

“Inhibit”—As used herein, inhibit is used to describe a reducing or minimizing effect. When a component or feature is described as inhibiting an action, motion, or condition it may completely prevent the result or outcome or future state completely. Additionally, “inhibit” can also refer to a reduction or lessening of the outcome, performance, and/or effect which might otherwise occur. Accordingly, when a component, element, or feature is referred to as inhibiting a result or state, it need not completely prevent or eliminate the result or state.

“Concave”—As used herein, concave is used to indicate a surface that is indented or recessed in any shape, including curved, notched, conical, or other mathematically-defined curvatures, as well as series of flat or curved surfaces that together form a recess, or other similar shapes.

In addition, certain terminology may also be used in the following description for the purpose of reference only, and thus are not intended to be limiting. For example, terms such as “height”, “width”, “longitudinal”, “upper”, “lower”, “above”, and “below” refer to directions in the drawings to which reference is made. Terms such as “front”, “back”, “rear”, and “side” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

The description set forth below discloses embodiments in the context of concentrated, photovoltaic solar power systems because they have particular advantages in that context. However, embodiments disclosed herein can be used in other contexts as well, such as concentrated thermal solar systems, other energy systems, and other optical systems.

Concentrator arrays typically have successive rows of concentrating elements. Some such arrays have solar receiver elements mounted to concentrating reflectors to conserve space and preserve ground cover. A level array of such concentrator/receiver pairs introduces undesirable paths for concentrated light to travel. For example, the light travel distance from a concentrator reflective surface to a receiver element may be different for light reflected from opposite sides of the reflective surface. This difference can introduce undesirable characteristics, such as intensity variations over the surface of the receiver and during slight misalignment. Additionally, an edge can reflect light to the solar receiver at an undesirably steep angle, which can reduce the optical transmission efficiency of the system. Steep angles of incidence occurring at the reflective surface also reduce optical transmission efficiency.

Solar energy collection systems can be in the form of concentrated or nonconcentrated systems. Additionally, nonconcentrated systems can include sun tracking systems or can be installed in fixed orientations relative to the sun. However, known concentrating systems are required to be moved for sun tracking purposes due to the optics employed for concentrating sunlight onto photovoltaic receivers or thermal receivers.

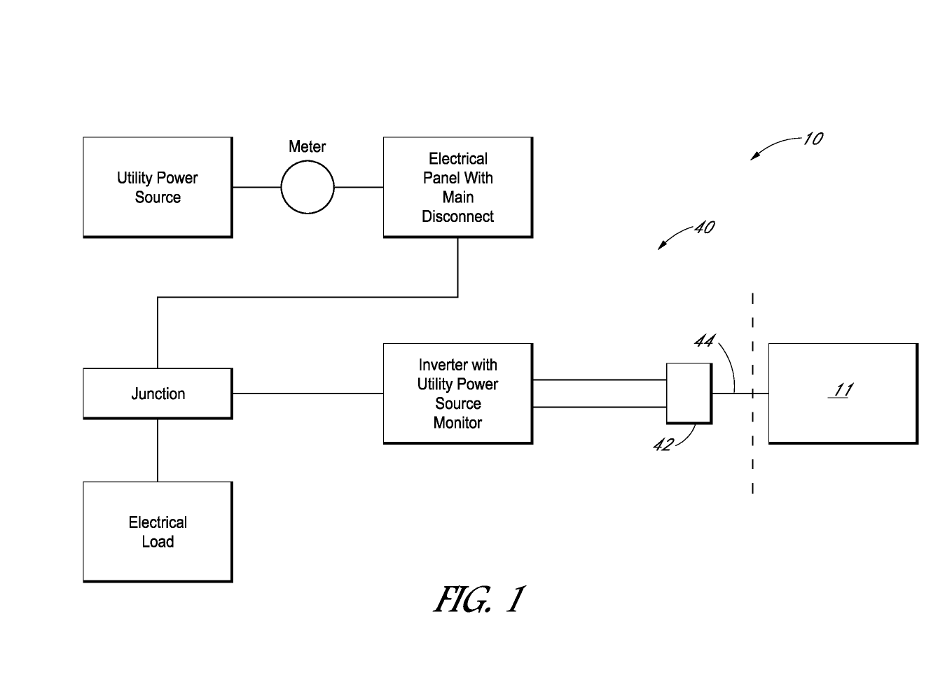

With reference to FIG. 1, a solar energy collection system 10 can include an array 11 of solar energy collection devices which can be in the form of concentrated or nonconcentrated, photovoltaic, or thermal solar energy collectors.

In the description set forth below, the solar energy collection system 10 is described in the context of a plurality of concentrating solar energy units, comprising a paired concentrating reflector and a photovoltaic receiver. Pluralities of these pairs are supported on common, pivotally adjustable, sun tracking support systems. Each of the units can include wiring for connecting the various photovoltaic receivers to each other and to other units.

The solar energy collection system 10 of FIG. 1 can include an electrical system 40 connected to an array 11 of solar energy units, with the array 11 acting as a power source connected to a remote connection device 42 with power lines 44. The electrical system 40 can also include a utility power source, a meter, an electrical panel with a main disconnect, a junction, electrical loads, and/or an inverter with a utility power source monitor. The electrical system 40 can be configured and can operate in accordance with the description set forth in U.S. Patent Publication No. 2010/0071744, the entire contents of which is hereby expressly incorporated by reference.

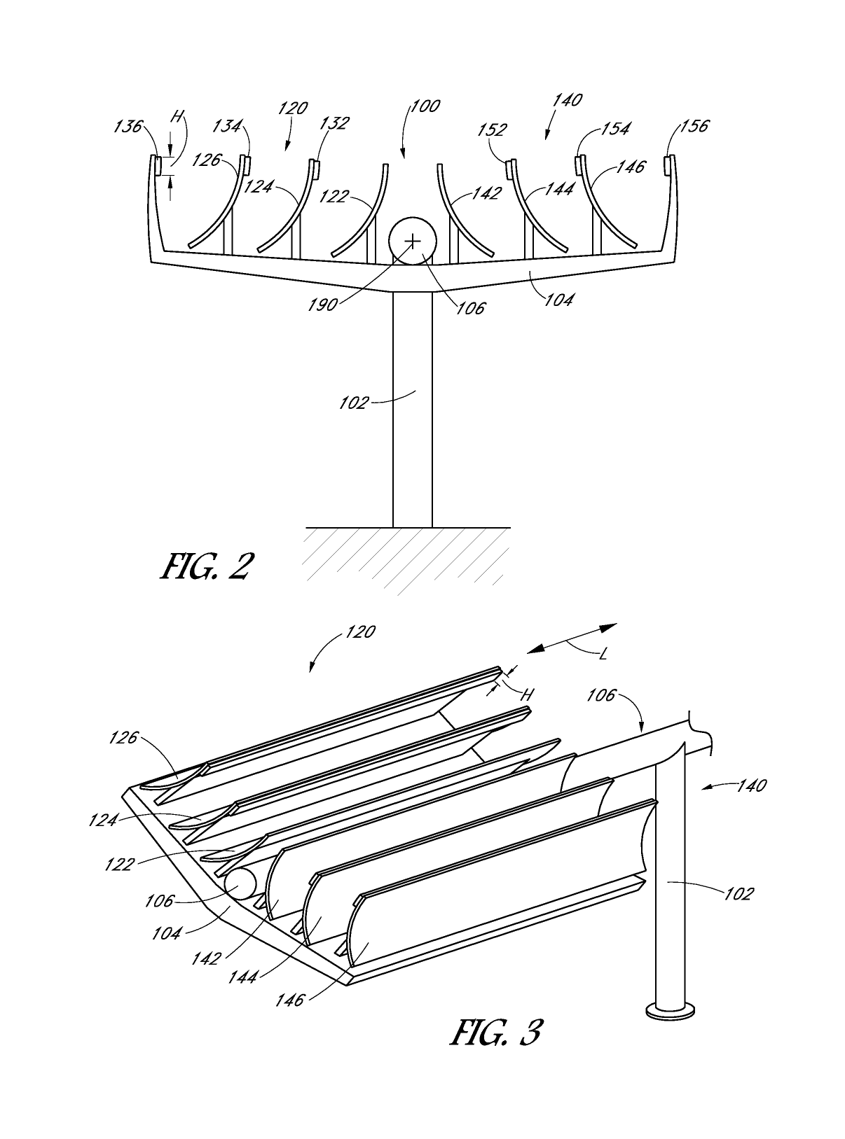

With reference to FIG. 2, a concentrating solar energy assembly 100 can support a plurality of concentrating reflectors 122, 124, 126, 142, 144, 146 each of which are configured to concentrate and reflect sunlight onto their associated (paired) receivers, 132, 134, 136, 152, 154, 156, respectively. As illustrated in FIG. 1, some of the photovoltaic receivers 132, 134, 152, 154, are mounted on the back sides of concentrating reflectors 124, 126, 142, 144, respectively. As shown in FIGS. 2 and 3, the concentrating reflectors 122, 124, 126, 142, 144, 146 and their associated (paired) receivers, 132, 134, 136, 152, 154, 156, respectively, extend along a longitudinal direction L, which can be considered the width direction thereof. Additionally, the receivers 132, 134, 136, 152, 154, 156 can be considered as having a height H extending in a direction transverse to the longitudinal direction L.

The concentrator assembly 100 can comprise a pier or a post 102 which supports a crossbeam 104 and a torque tube 106. The crossbeam 104, in turn, supports the plurality of paired concentrating reflectors and receivers noted above, which can be referred to as first and second groups 120, 140 of concentrator-receiver pairs. As illustrated in FIG. 2, the first group of concentrator units 120 face in one direction, and the second group of concentrator units 140 are positioned facing the opposite direction, with a changeover between them occurring at the torque tube 106.

The post 102 can be a single post of one of several supporting the solar concentrator assembly 100. The post 102 is preferably anchored within a foundation in the ground to support it. The post 102 can be a solid or hollow member of sufficient size and cross-sectional characteristics to support the solar concentrator assembly 100. The post 102 can be formed of metal, such as steel, aluminum, and similar high strength metals, or alternative materials. For example, concrete or ceramic can be used in some embodiments, as desired.

The crossbeam 104 is supported by the post 102 and the torque tube 106. The crossbeam 104 can have a substantially horizontal shape when the assembly 100 is oriented at a “noon” position. Additionally, the crossbeam 104 can include an upwardly angled portion for positioning individual concentrator units at different vertical heights, relative to the rotational axis 190 of the torque tube 106. The torque tube 106 can be supported by a bearing or bushing (not shown) or other assembly permitting rotation of the torque tube 106 about its long axis, i.e., rotational axis 190. In some embodiments, a motor (not shown) or other driving device can be situated between the post 102 and the torque tube 106. A controller (not shown) can be used to drive the motor, and thus drive the torque tube 106 through a sun tracking motion.

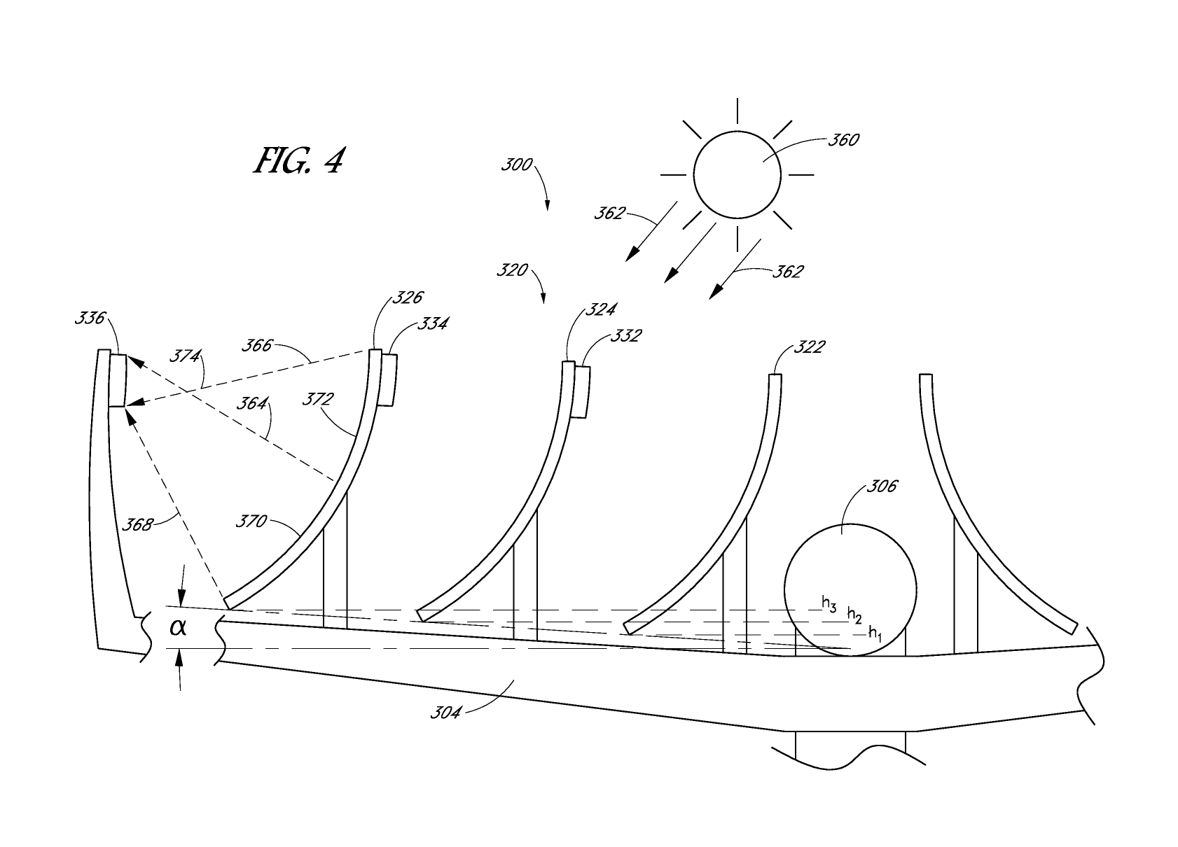

FIG. 4 illustrates a further embodiment of the assembly 100 and is identified generally by the reference numeral 300. Parts, components, and features of the system 300 that are the same or similar to the system 100 are identified with the same reference numeral, except 200 has been added thereto.

With continued reference to FIG. 4, the sun 360 radiates sunlight 362. Sunlight 362 can be considered “focused” light because individual rays of light output from the sun 360 are generally parallel, or nearly perfectly parallel, in the context of earth-bound machinery, which is millions of miles from the sun 360, and very small compared to the diameter sun 360. The concentrating reflectors 322, 324, 326 reflect and concentrate the sunlight 362 onto the receivers 332, 334, 336.

In the embodiment of FIG. 4, the receivers 332, 334, 336 are oriented with their light sensitive side (described in greater detail below) facing toward the concentrating reflectors. In some embodiments, the receivers 332, 334 are positioned with their upper edges near the upper edges of the corresponding concentrating reflectors 324, 326 of adjacent concentrator-receiver pairs.

The concentrators 322, 324, 326, are each configured to generate two beams of light, generating different irradiation intensity profiles on the corresponding receivers 332, 334, 336 such that the beams of light are superimposed such that their irradiation are summed at the surface of the receivers 324, 326, 336. Additionally, the concentrator-receiver pairs are mounted at different heights H2, H3, H4, relative to the crossbeam 104 such that the lower edges of the reflectors 322, 324, 326 follow along an angle α relative to horizontal in the orientation illustrated in FIG. 4. However, other arrangements and orientations of the receivers relative to the reflectors can also be used.

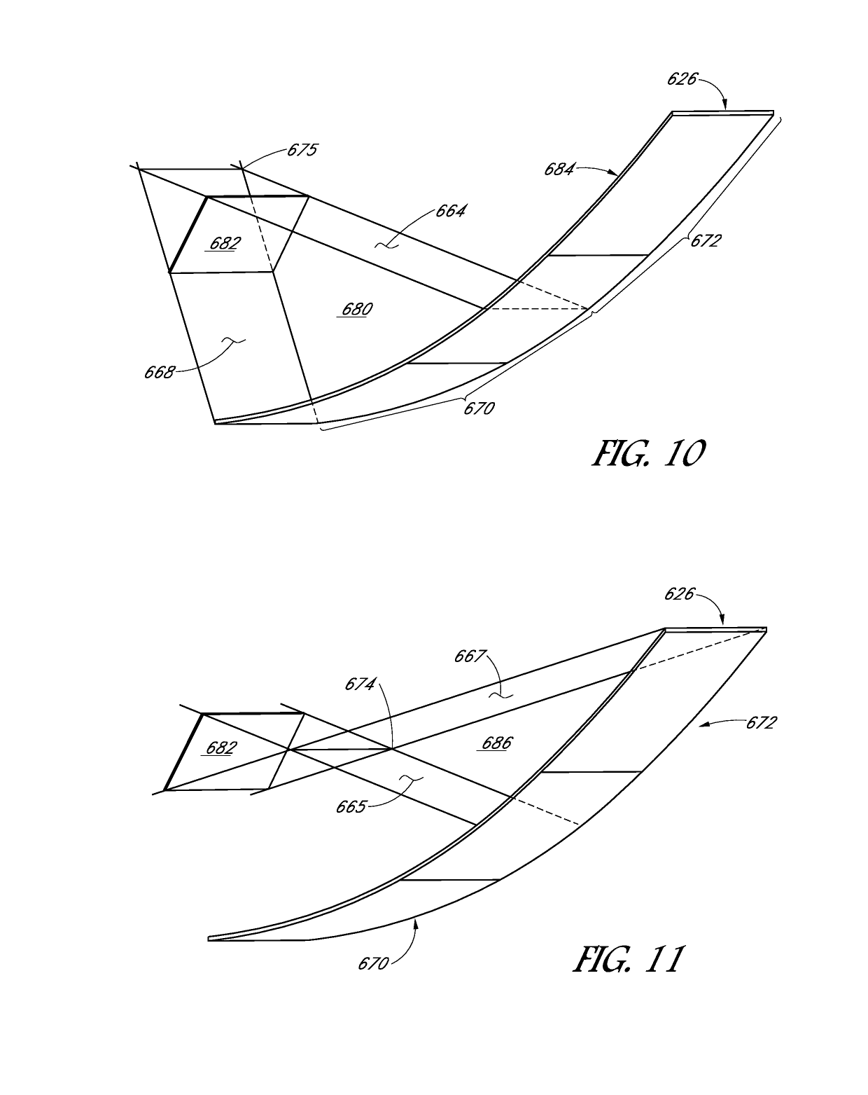

With continued reference to FIG. 4, the two beams of reflected sunlight can be considered as being defined by beam boundaries 368, 364, 366. For example, each of the reflectors 322, 324, 326 can include a lower portion 370 and an upper portion 372. The beam of light reflected by the lower portion 370 can be considered as being bound by boundaries 368 and 364. The beam of light reflected by the upper portion 372 can be considered as being bound by boundaries 366 and 364, described in greater detail below with reference to FIGS. 10-16. These two different beams of light are directed toward the light sensitive side of the receivers 332, 334, 336. The light traveling along the boundary 366 travels a shorter distance the receiver 336 than the light traveling along boundary 368.

Although the top and bottom edges of the beams of light are illustrated as impinging on substantially entirely the face of the receiver 336, the bands of sunlight projected onto the light sensitive side of the receiver 336 can be narrower and focused on a solar cell positioned at a desired location on the light sensitive side of the receiver 336. Thus, a narrower band of concentrated sunlight can be produced in a precise geometry, as closely as possible on the solar cells within the receiver 336 so as to not waste reflected light on nonfunctional portions of the receiver 336.

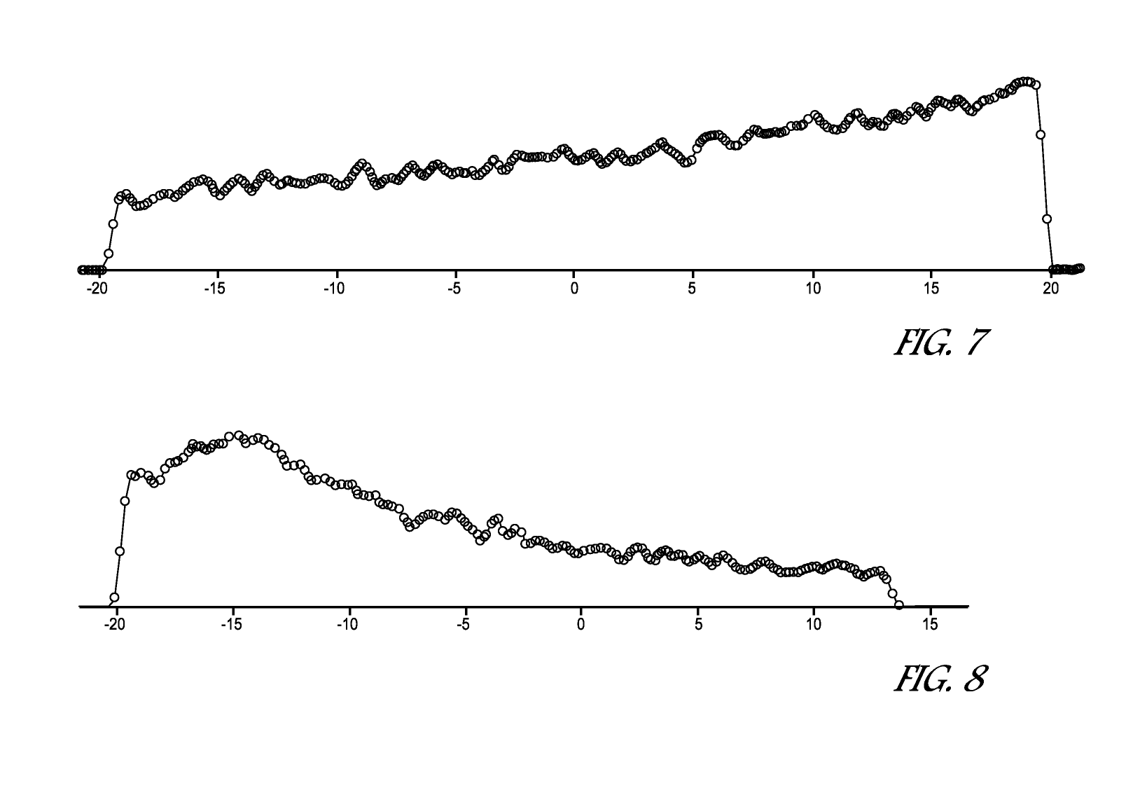

Because the lower edge of the concentrating reflector 326 is positioned furthest from the receiver 336, the resulting beam of light bounded by boundaries 368, 364 varies in intensity, projecting a band of light on the receiver 336 that varies in intensity with the lowest intensity at the lower edge of the receiver 336 and the highest intensity at the upper edge of the receiver 336. However, because the beam of light generated by the upper portion 372 of the concentrating reflector 326 converges to a focal point 374 between the reflector 326 and the receiver 336, the intensity profile of the reflected light projected onto the receiver 336 is inverted, with the highest intensity at the lower edge of the receiver 336 and the lowest intensity at the upper edge of the receiver 336. Similar intensity profiles are described below with reference to FIGS. 7 and 8.

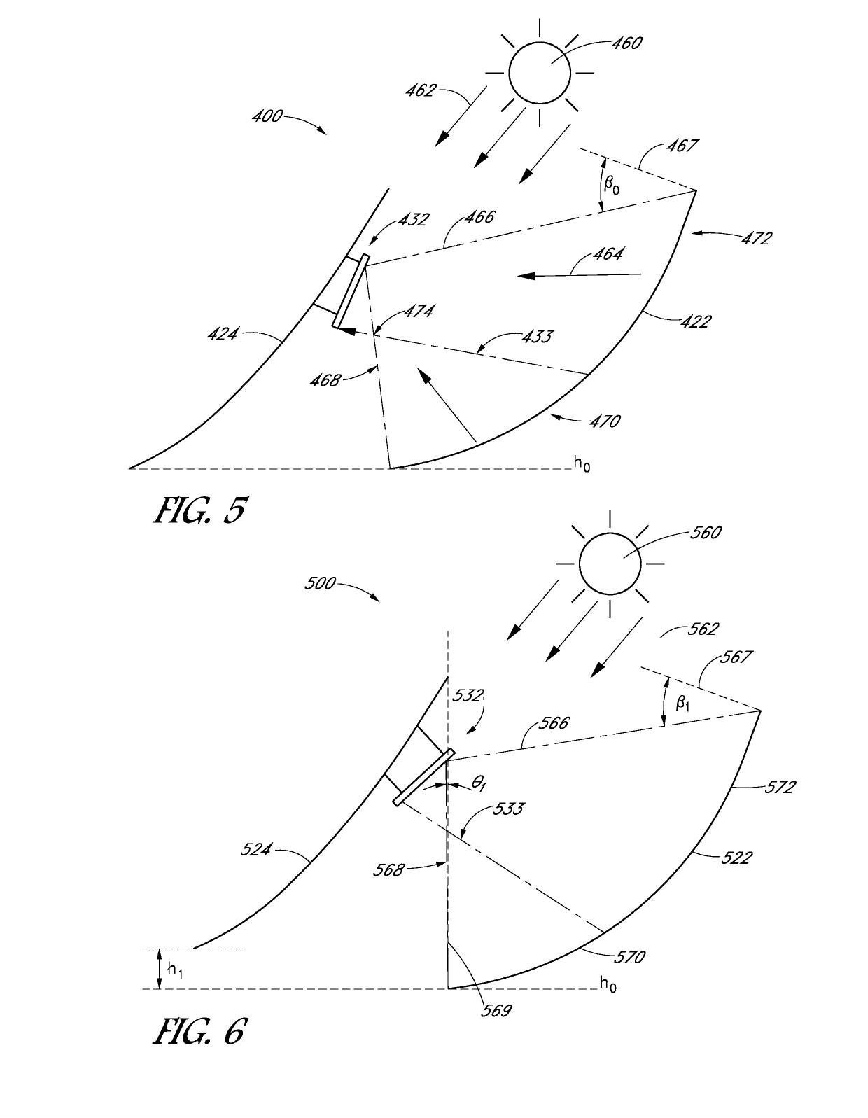

With reference to FIG. 5, other orientations of reflectors and receivers can provide different radiation intensity profiles. The embodiment in FIG. 5 is identified generally by the reference numeral 400, the parts, components, and features of the assembly 400 that are the same or similar to those of the assembly 300 are identified with the same reference numeral, except that 100 has been added thereto.

As shown in FIG. 5, the receiver 432 is mounted lower on the adjacent reflector 424. As such, the sunlight traveling along the boundary 468 travels a shorter distance than the sunlight traveling along the boundary 466. Thus, the beam of light defined by the boundaries 466, 433 varies in intensity with the greatest intensity at the lower edge of the receiver 432 and the weakest intensity of the upper edge of the receiver 432. However, the beam of light produced by the lower portion 470 of the reflector 422, because it has a focal point 474 disposed between the reflector 422 and the receiver 432, varies with the greatest intensity at the upper edge 432 of the receiver 432 and the weakest intensity at the lower edge of the receiver 432. The intensities of these two beams of light can be summed at the surface of the receiver 432 to produce a more uniform irradiation intensity profile on the receiver 432.

It should also be noted that the sunlight reflected onto the receiver 432 also varies in accordance with an effective intensity affected by the angle of incident of light on the receiver 432. This is because some photovoltaic receivers 432 receive sunlight in a highly efficient manner when sunlight is perpendicular to the light sensitive side of the receiver, and less efficiently when the light impinges on the light sensitive side of the receiver 432 at a non-normal angle. For example, an upper edge normal line 467 extends perpendicularly to the reflective surface at the top edge of the concentrator 422. The top edge of concentrated sunlight 466 forms an angle β₀ with the upper edge normal 467. It is desirable to reduce the angle β₀. Various parameters and the effects thereof are disclosed in U.S. Patent Publication number 2012/0031393, the entire contents of which are hereby incorporated by reference.

FIG. 6 illustrates yet another variation of the system 400, identified generally by the reference numeral 500. The components, parts, and features of this assembly 500 that are similar or the same as the assembly 400 are identified with the same reference numeral, except that 100 has been added thereto.

As shown in FIG. 6, a concentrating reflector 524 to which the receiver 532 is mounted, is vertically offset to a height H₁ relative to concentrating reflector 522. In this configuration, the angle θ₁ is reduced. This can increase efficiency of the solar receiver 532 by adjusting the angle at which concentrated sunlight at or near the bottom of the receiver 532 travels through the surface of the receiver 532. Additionally, reflectance of the mirrored surface of the concentrating reflector 522 is increased because the incident angle of unconcentrated sunlight 562 is decreased. Additionally, the receiver 532 is mounted at a position higher on the concentrating reflector 524 than that illustrated in FIG. 5. This reduces the size of the angle β₁ which can additionally increase efficiency of the concentrator-receiver pair. Other configurations can also be used.

With reference to FIGS. 7-9, and FIG. 4, the intensity profiles of the band of light produced by the beams of light which are generated by the different portions 370, 372 of the reflectors 322, 324, 326 can produce nonuniform intensity profiles, despite careful tuning of the curvatures and angles and orientations of the various components, described above. For example, FIG. 7 is an irradiation intensity profile which can be produced by the lower portion 370 of the concentrating reflector 326 (FIG. 4). The data represented by the graph of FIG. 7 was generated by a configuration illustrated in FIGS. 10-16. Additionally, the irradiation intensity profile of FIG. 8 reflects the intensity profile variation resulting from an upper portion, for example, an upper portion similar to the upper portion 372, of the reflector 326 of FIG. 4.

In the graphs of FIGS. 7-9, the point identified as zero corresponds to approximately the center of a receiver, such as the receiver 336. The positive numbers extending from 0 to 20 represent millimeters from the center of the receiver 336. The left side of the graph extending from 0 to −20 represents the portions of the receiver 336 from the center to the bottom edge thereof.

As shown in FIG. 7, the intensity profile generated by the lower portion 370 of the reflector 326 can vary with the lowest or weakest intensity at 20 millimeters down from the center of the receiver 336 and the highest or strongest intensity at 20 millimeters above the center of the receiver 336.

On the other hand, the intensity profile generated by the upper portion 372 of the reflector 326 is inverted relative to the profile of FIG. 7, with the most intense portion of the profile at the lower edge of the receiver 336 and the weakest intensity portion at the upper edge of the receiver 336. This inverted profile of FIG. 8 results because the curvature of the upper portion 372 produces a focal point 374 that is disposed between the reflector 326 and the receiver 336. However, the beam of light produced by the lower portion 370 does not include a focal point between the reflector 326 and the receiver 336. Thus the intensity profiles vary in the opposite or inversed relationship.

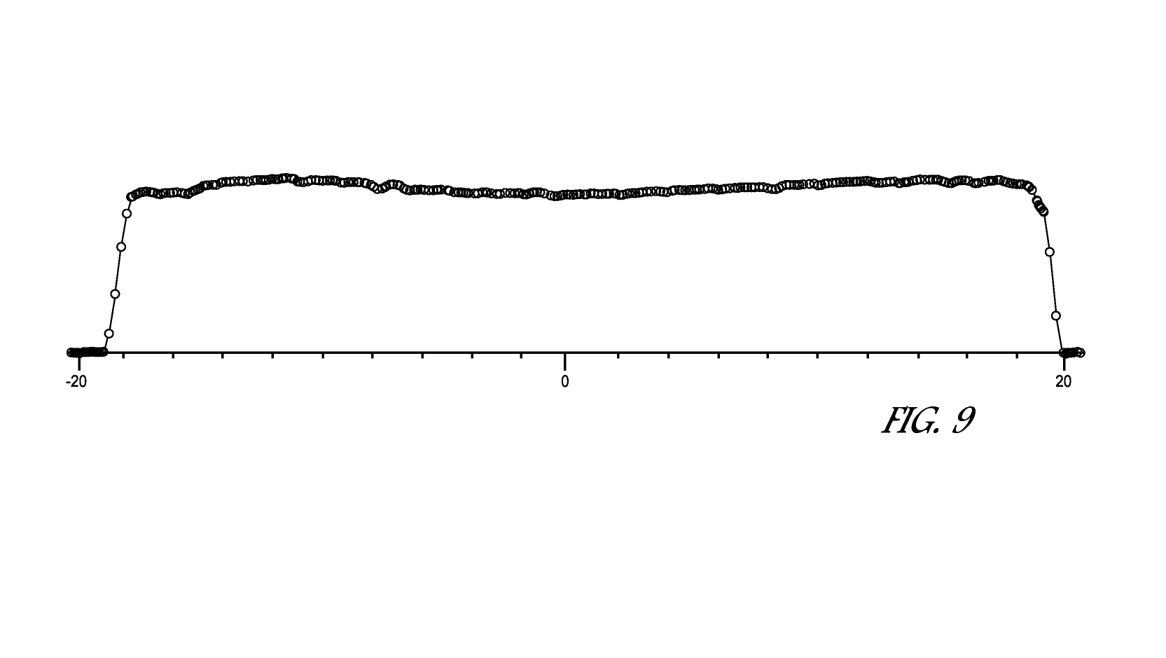

Thus, as shown in FIG. 9, when the intensities of these two beams of light are summed, the intensity profile can be more uniform.

The geometry of various embodiments of concentrating reflectors is illustrated in FIGS. 10-13.

With reference to FIG. 10, a concentrating reflector 626 can also be configured to produce two beams of light that intersect at a plane and produce different irradiation intensity profiles at the plane, and thus when summed, produce a more uniform intensity profile. The parts and components of the concentrating reflector 626 are identified with the same reference numerals as those used to describe the concentrating reflector 326, except that 300 has been added thereto.

With reference to FIG. 10, the lower portion 670 is configured to produce a converging beam of reflected sunlight 680, bounded by lower boundary 668 and upper boundary 664. The boundaries 668 and 664 can be considered as planer boundaries of the beam 680.

The beam 680 is a converging beam, and a plane 682 can be defined within the beam 680. In this context, the beam 680 converges to a focal point 675 at a position further from the concentrating reflector 626 than the plane 682. The curvature of the concentrating reflector 626 can be defined by a high order polynomial, such as a 20, 30, 40, or higher order polynomials, conic sections, other mathematical functions or shapes using known techniques. The concentrating reflector 626, and more specifically, the reflective surface 684 can be manufactured so as to follow any desired geometric shape, which can be defined by a mathematical function, such as the high order polynomial noted above. Such manufacturing techniques are well known, and include a sag bending technique.

With reference to FIG. 11, the concentrating reflector 626 can also include an upper portion 672 with a different curvature, configured to produce a beam of light 686. As shown in FIG. 11, the beam 686 is a converging beam, forming a focal point or focal line 674 that is disposed between the plane 682 and the concentrating reflector 626.

As such, the beam 680 illustrated in FIG. 10 produces a varying irradiation intensity profile as illustrated in FIG. 7, with the weakest irradiation at the lower edge of the plane 682 and the strongest irradiation at the upper edge of the plane 682. On the other hand, the beam 686 (FIG. 11) produces the strongest intensity irradiation at the lower edge of the plane 682 and the weakest irradiation at the upper edge of the plane 682.

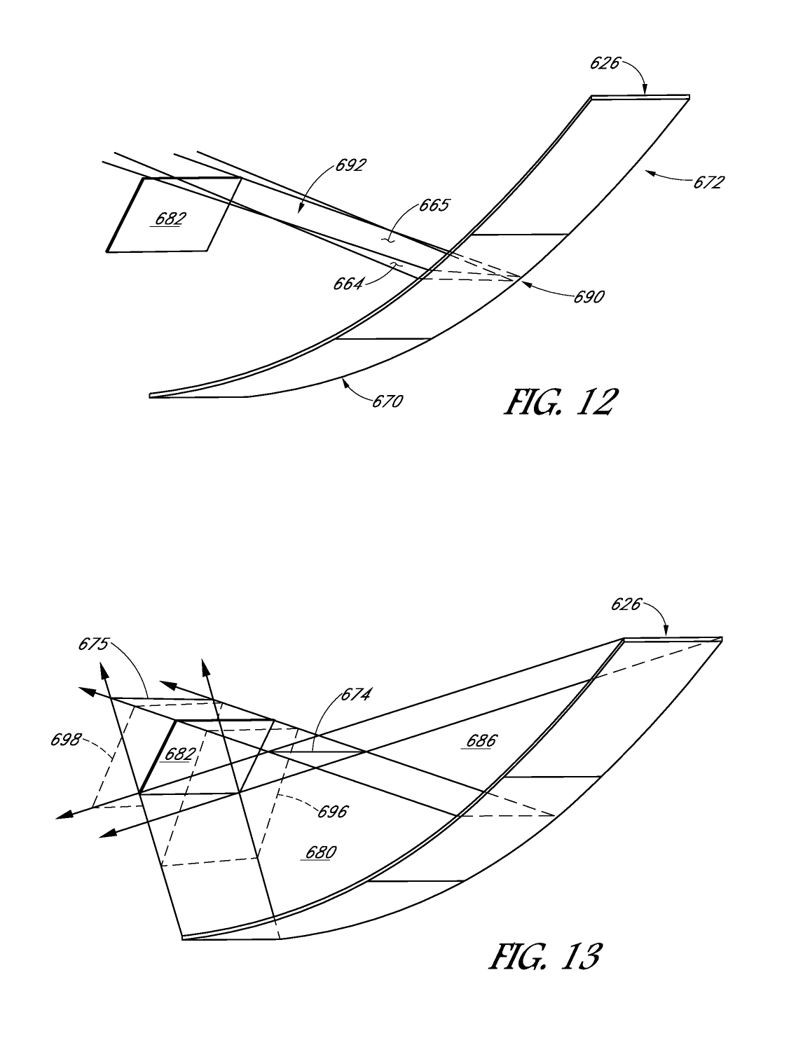

With reference to FIG. 12, an intermediate portion 690 can be disposed between the lower and upper portions 670, 672. The intermediate portion 690 can produce a beam 692 that is bound by the boundaries 665 and 664. The beam 692 is created by the transition from the curvature of the lower portion 670 to the upper portion 672, as a function of the high order polynomial noted above. Thus, the beam 692 can create a concentrated intensity that may be compensated for using the superposition of the beams 680, 686. Optionally, the curvature of the intermediate portion 690 can be configured to direct the beam 692 off of the plane 682 so as to avoid undesirable concentrations of intensity. The intermediate portion can have a curvature following a mathematically smooth and continuous transition, resulting from, for example, a high order polynomial noted above, between the curvatures of the lower and upper portions 670, 672.

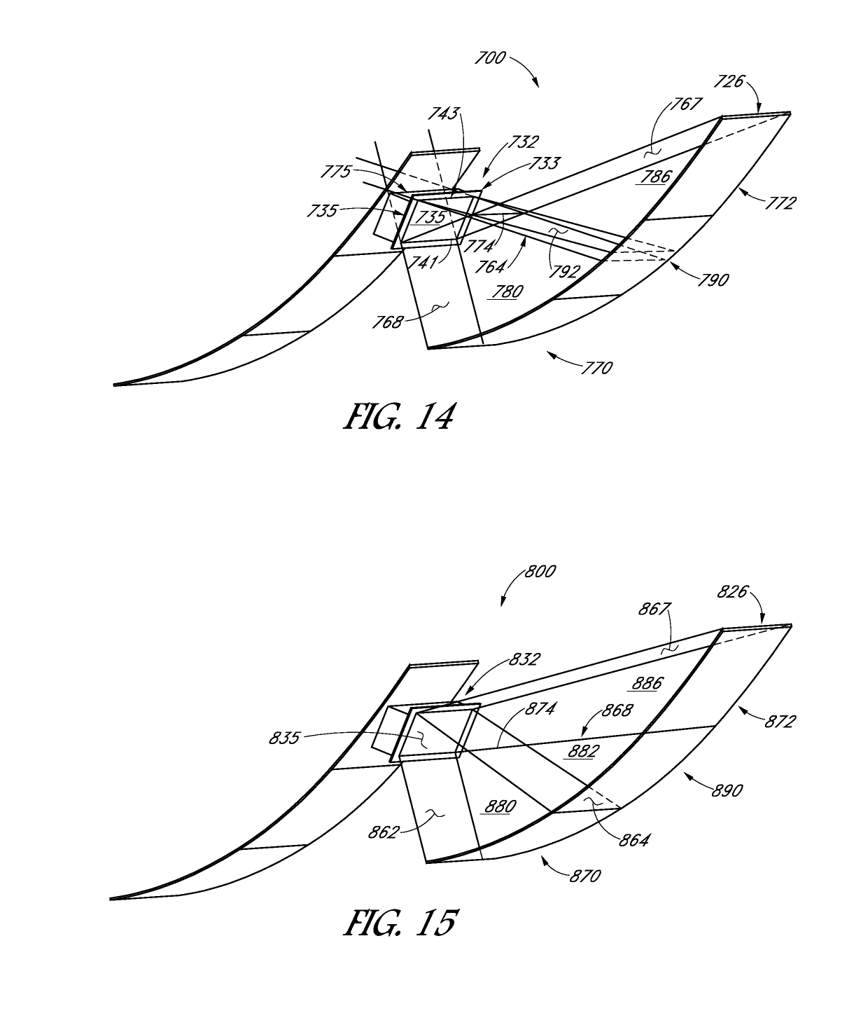

With reference to FIG. 13, the beams 680, 686 are superimposed and thus substantially coincident at the plane 682. Reference planes 696, 698, which are parallel to plane 682, illustrate that at positions between the focal point 674 and the plane 682, the beams 686 and 680 are also substantially coincident, as illustrated by the referenced plane 696. Similarly, at positions between the focal point 675 and the plane 682, the beams 686, 680 are also substantially coincident. In each case, the beams 680, 686 overlap by a significant amount, for example, by at least about 20-30%. At the plane 682, the beams 680, 682 are substantially coincident over the entire height of the plane 682.

With reference to FIG. 14, a further embodiment, identified generally by the reference numeral 700, is illustrated therein. Parts, components and features of the assembly 700 that are similar to or the same as the assembly 600 are identified with the same reference numeral, except that a 100 has been added thereto.

As shown in FIG. 14, the assembly 700 can include a paired concentrating reflector 726 and a receiver 732. The receiver 732 can be constructed in accordance with the description of receiver 332 described above. Further, in FIG. 14, the receiver 732 is illustrated as having a light sensitive side 733. The light sensitive side 733 can include one or an array of solar cells 735 disposed within an encapsulant 737. The encapsulant and/or frame of the receiver 732 can extend around the periphery of the solar cells 735. Thus, the light sensitive portion of the light sensitive side 733 can be considered as being the exposed part of the solar cells 735, which are exposed to light through the encapsulant material 733 and optionally other protective coverings, such as glass or other materials.

As such, as illustrated in FIG. 14, the light sensitive portion 735 can be slightly smaller than the light sensitive side 733 of the receiver 732. Thus, the lower and upper portions 770, 772 of the concentrating reflector 726 can be configured to produce beams 780, 786 that are optimized for creating bands of light on the light sensitive portion 735 with little or no sunlight being directed to the nonsensitive portions of the light sensitive side 733, such as the encapsulant material extending around the periphery of the solar cells 735 and/or a frame of the receiver 732.

Optionally, the intermediate portion 790 can be configured to produce a beam 792 that impinges on a portion of the upper edge of the light sensitive portion 735 or onto the nonsensitive encapsulant surrounding the solar cell 735.

As such, the light sensitive portion 735 of the receiver 732 is in essentially the same shape and orientation as the plane 682 of FIGS. 10-11.

As such, the beam 780 projects a band of light onto the light sensitive portion 735 that has the strongest intensity at the lower edge 741 of the light sensitive portion 735 and the weakest intensity at the upper edge 743 of the light sensitive portion 735. On the other hand, because the beam of light 786 has a focal point 774 disposed between the receiver 732 and the concentrating reflector 726, the beam 786 produces a band of light on the light sensitive portion 735 that is the weakest at the lower edge 741 of the receiver and the strongest at the upper edge 743. As such, the beam 780 would produce an irradiation intensity profile similar to FIG. 8 and the beam 786 would produce an irradiation intensity profile similar to FIG. 7.

Thus, with the beams 780, 786 producing superimposed bands of light on the light sensitive portion 735, the summed irradiation can produce an irradiation intensity profile similar to that of FIG. 9, which is more uniform than either of the profiles illustrated in FIG. 7 or 8.

In the embodiments of FIGS. 10-14, the upper portions, 772 are disclosed as generating beams 686, 786, which have focal points 674, 774, that are disposed between the concentrating reflector and the associated receiver while the lower portions 670, 770 are disclosed as forming beams 680, 780 which have a focal point 675, 775, respectively, that is disposed in a position that is not between the receiver and the concentrating reflector. However, in some embodiments, the converging shape of the beams 680, 686 can be varied such that the beams 680 and 780 produce focal points between the receiver and the concentrator and the beams 686, 786 produce focal points that are not between the receiver and the concentrator. Other variations are also possible.

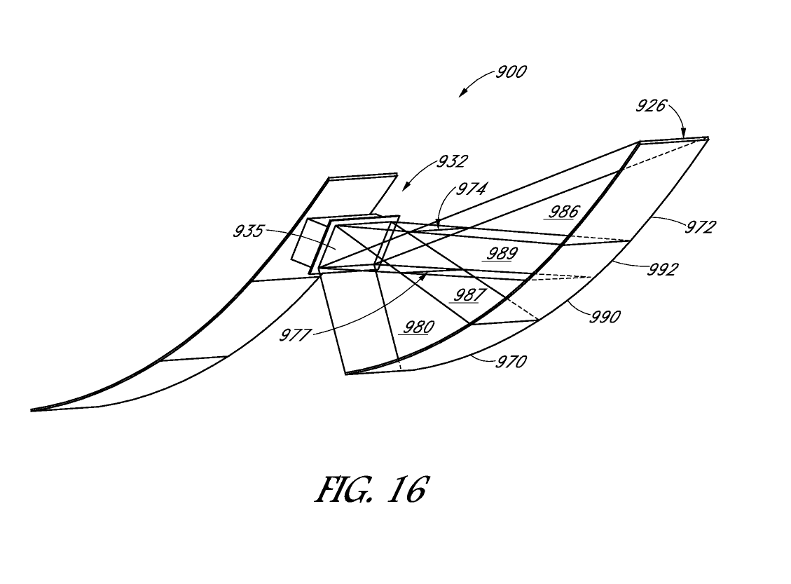

FIG. 15 illustrates a further embodiment of a solar assembly, identified generally by the reference numeral 800. Parts, components, and features of the assembly 800 that are the same or similar to that of the assembly 700 identified with the same reference numeral, except that 100 has been added thereto.

As shown in FIG. 15, the concentrating reflector 826 is configured to produce three beams 880, 886, and 887, which together produce three superimposed bands of light that are substantially coincident on the light sensitive portion 835 of the receiver 832. More specifically, the concentrating reflector 826 includes a lower portion 870, an upper portion 872, and an intermediate portion 890. The beam 880 is bounded by boundary 868 and boundary 864. The beam 887 is bounded by the boundary 864 and boundary 865 which produces a focal point 874 disposed between the receiver 832 and the concentrating reflector 826. The beam 886 is defined by the boundary 867 and boundary 868. In this configuration, neither of the beams 880, 886 include focal points between the receiver 832 and the concentrating reflector 826. Rather, the focal points of the beams 880, 886 are (not illustrated) disposed further from the concentrating reflector 826 than the receiver 832.

As illustrated in FIG. 15, all three of the beams 880, 887, and 886 are substantially coincident at the light sensitive portion 835 and thus create three superimposed bands of light on the light sensitive portion 835.

FIG. 16 illustrates a further embodiment of the solar assembly, identified generally by the reference numeral 900. Parts, components and features of the assembly 900 that are the same or similar to the assembly 800 are identified with the same reference numerals, except 100 has been added thereto.

As illustrated in FIG. 16, the concentrating reflector 926 includes a lower portion 970 producing a beam 980, an upper portion 972 producing a beam 986, a lower intermediate portion 990 producing a beam 987 and an upper intermediate portion 992 producing a beam 989. The beams 980, 987, 989, 986 all project bands of light onto the light sensitive portion 935 of the receiver 932 which are superimposed on each other and substantially coincident with the light sensitive portion 935.

In the assembly 900, the beams 980, 989 do not include focal points between the receiver 932 and the concentrating reflector 926. Rather, the beams 980, 989 produce focal points (not shown) that are disposed further from the reflector 926 and the receiver 932. On the other hand, the beams 987 and 986 produce focal points 974, 977, both of which are disposed between the receiver 932 and the concentrator 926. As such, the beam 980 can produce a resulting intensity profile like that of FIG. 8 and the beam 986 can produce an intensity profile like that of FIG. 7 thus, when summed, can produce a more uniform intensity profile like that of FIG. 9.

Similarly, the beam 987 produces a focal point 977, and thus can produce an intensity profile like that of FIG. 7, but perhaps with less variation between the minimum and maximum points. The beam 989 can produce an intensity profile like that of FIG. 8, but similarly with less variation between the minimum and maximum points. Thus, when added, the beams 989 and 987 can produce a band of light on the light sensitive portion 935 with a more uniform intensity profile, like that of FIG. 9. As such, with two pairs of offsetting nonuniform intensity profiles, the resulting overall intensity profile can be more uniform, like that of FIG. 9.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features.

What is claimed is:

1. A concentrated solar power unit, comprising:
a paired sunlight concentrating reflector and photovoltaic receiver, arranged such that incoming sunlight from the sun is reflected by the first sunlight concentrating reflector, onto the first photovoltaic receiver;
the sunlight concentrating reflector having a reflective side facing a sunlight sensitive side of the photovoltaic receiver, the sunlight sensitive side of the photovoltaic receiver comprising a receiver lower edge, a receiver upper edge, and a light sensitive portion disposed between the received upper edge and the receiver lower edge, the sunlight concentrating reflector comprising a concentrator lower edge and a concentrator upper edge;
the reflective side of the sunlight concentrating reflector comprising a first lower portion extending between the concentrator lower edge and an intermediate point on the reflective side and a first upper portion extending between the intermediate point and the concentrator upper edge;
the first lower portion of the reflective side having a first curvature configured to reflect the incoming sunlight into a first lower beam projecting a first band of reflected sunlight extending over substantially an entire height of the light sensitive portion of the first photovoltaic receiver;
the first upper portion of the reflective side having a second curvature configured to reflect the incoming sunlight into a first upper beam projecting a second band of reflected sunlight onto the receiver overlapping the first band of reflected sunlight;
wherein one of the first lower beam and the first upper beam has a first focal point between the reflective side and the sunlight sensitive portion and the other of the first lower beam and the first upper beam has a second focal point that is not between the reflective side and the sunlight sensitive portion.

2. The solar power unit according to claim 1, wherein the intermediate portion of the reflective side comprises a smooth transition between the first upper portion and the first lower portion.

3. The solar power unit according to claim 1, wherein the photovoltaic receiver comprises at least one solar cell encapsulated in an encapsulate material, the light sensitive portion comprising a portion of the at least one solar cell exposed to sunlight through the encapsulate material.

4. The solar power unit according to claim 1, wherein the second band extends over substantially the entire height of the light sensitive portion, the first and second bands of light being projected onto the light sensitive portion simultaneously.

5. The solar power unit according to claim 1, wherein the first lower beam and the first upper beam are converging beams.

6. The solar power unit according to claim 1, wherein the other of the first lower beam and the first upper beam has a second focal point that is further from the reflective side than the light sensitive portion.

7. The solar power unit according to claim 1, the reflective side comprising a second lower portion extending between the concentrator lower edge and the intermediate point, the second lower portion having a third curvature configured to reflect incoming sunlight into a second lower beam projecting a third band of light onto the light sensitive portion.

8. The solar power unit according to claim 7, the reflective side comprising a second upper portion extending between the concentrator upper edge and the intermediate point, the second upper portion having a fourth curvature configured to reflect incoming sunlight into a second upper beam projecting a fourth band of light onto the light sensitive portion, the first, second, third and fourth bands of light being superimposed simultaneously on the light sensitive portion.

9. A concentrating reflector comprising:
a concave, reflective surface extending along a longitudinal direction having first and second longitudinal ends and extending in a transverse direction between upper and lower edges;
the reflective surface comprising at least a first portion having a first curvature, a second portion having a second curvature, and an intermediate portion disposed between the first and second portions;
the first portion of the reflective surface extending between the lower edge and the intermediate portion, the second portion of the reflective surface extending between the upper edge and the intermediate portion;
the first and second curvatures being configured to reflect first and second reflected beams of light, respectively, which are substantially coincident at a plane spaced from the reflective surface, forming a planar band of light comprising a superposition of the first and second beams;
wherein the first reflected beam of light has a first focal point and the second reflected beam of light has a second focal point, the second focal point spaced closer to the reflective surface than the first focal point, the plane being disposed between the first and second focal points.

10. The reflector according to claim 9, wherein the intermediate portion of the reflective side comprises a smooth and continuous transition between the first upper portion and the first lower portion.

11. The reflector according to claim 9, wherein the first and second reflected beams extend over substantially an entire height of the planar band of light.

12. The reflector according to claim 9, wherein the first and second reflected beams are converging beams.

13. The reflector according to claim 9, wherein first reflected beam has a first intensity distribution on the plane, decreasing from a lower portion of the plane to an upper portion of the plane, the second reflected beam having an increasing intensity from the lower portion of the plane to the upper portion of the plane.

14. The reflector according to claim 9, wherein the reflective side comprises a third portion extending between the first and second portions, the third portion having a third curvature configured to reflect incoming sunlight into a third reflected beam which is substantially coincident with the first and second beams at the plane.

15. A concentrated solar power unit, comprising:
a photovoltaic receiver;
a sunlight concentrating reflector having a reflective side facing toward a light sensitive portion of the photovoltaic receiver, the reflective side comprising a lower portion extending between a lower edge of the reflective side and an intermediate point on the reflective side, and an upper portion extending between the intermediate point and an upper edge of the reflective side;
the lower portion reflecting sunlight into a lower beam projecting a first band of reflected sunlight onto a light sensitive portion of the photovoltaic receiver;
the upper portion of the reflective side reflecting sunlight into an upper beam projecting a second band of reflected sunlight overlapping the first band of reflected sunlight;
wherein one of the lower beam and the upper beam has a first focal point between the reflective side and the sunlight sensitive portion and the other of the first lower beam and the first upper beam has a second focal point that is not between the reflective side and the sunlight sensitive portion.

16. The solar power unit according to claim 15, wherein the second band extends over substantially the entire height of the light sensitive portion, the first and second bands of light being projected onto the light sensitive portion simultaneously.

17. A concentrated solar power unit, comprising:
a photovoltaic receiver having a light sensitive portion;
means for directing first and second beams of reflected sunlight, respectively, the first and second beams of impinging on the light sensitive side of the photovoltaic receiver with first and second different, non-uniform, irradiation intensity profiles, and summing the first and second beams of light so as to produce a resulting irradiation intensity profile that is more uniform than both of first and second different, non-uniform, irradiation intensity profiles.

18. The concentrated solar power unit according to claim 17 additionally comprising means for directing third and fourth beams of reflected sunlight onto the receiver forming third and fourth different, non-uniform, irradiation intensity profiles, and summing the first, second, third and fourth beams of light so as to produce a resulting irradiation intensity profile that is more uniform than the first, second, third, and fourth different, non-uniform, irradiation intensity profiles.

19. A concentrated solar power system, comprising:
an array of paired sunlight concentrating reflectors and photovoltaic receivers, the array including at least a plurality of first sunlight concentrating reflectors and a plurality of first photovoltaic receivers;
each of the first sunlight concentrating reflectors and each of the first photovoltaic receivers arranged such that incoming sunlight from the sun is reflected by the first sunlight concentrating reflectors, along a reflected direction skewed relative to the incoming sunlight, onto the first photovoltaic receivers;
each of the first sunlight concentrating receivers having a reflective side facing toward a sunlight sensitive side of respective first photovoltaic receivers, the sunlight sensitive side of the first photovoltaic receivers comprising a receiver lower edge and a receiver upper edge, the first sunlight concentrating reflectors comprising a concentrator lower edge and a concentrator upper edge, wherein the first photovoltaic receivers are fixed in an orientation such that a lower spacing between the receiver lower edges and the concentrator lower edges is smaller than an upper spacing between the receiver upper edges and the concentrator upper edges;
the reflective sides of each of the first sunlight concentrating reflectors comprising a first lower portion extending between the concentrator lower edge and an intermediate point on the reflective side and a first upper portion extending between the intermediate point and the concentrator upper edge;
each of the first lower portions of the reflective sides having a first curvature configured to reflect and concentrate the incoming sunlight into a first concentrated beam projecting a first band of reflected sunlight extending substantially an entire height of the light sensitive side of a respective one of the first photovoltaic receivers between the receiver upper and receiver lower edges and with a first focal point further from the reflective surface than the light sensitive surface; and
wherein the first upper portion of each of the reflective sides comprises a second curvature configured to reflect and concentrate the incoming direct sunlight into a second concentrated beam projecting a second band of reflected sunlight overlapping the first band of reflected sunlight with a second focal point disposed between the reflective surface and the light sensitive surface.
